(19) United States
(12) Patent Application Publication
(10) Pub. No.: US 2003/0227247 A1
(43) Pub. Date: Dec. 11, 2003

(54) Deflection yoke having a compensation function of pin distortion in a middle portion

(75) Inventor: Yun Ki Hong, Suwon-Shi (KR)

Correspondence Address: DARBY & DARBY P.C., 805 Third Avenue, New York, NY, 10022, US

(73) Assignee: SAMSUNG ELECTRO-MECHANICS CO., LTD., Kyungki-Do (KR)

(21) Appl. No.: 10/330,743

(22) Filed: Dec. 27, 2002

(30) Foreign Application Priority Data
Jun. 7, 2002 (KR) 2002-31879

(51) Int. Cl. H01J 29/70

(52) U.S. Cl. 313/440

(57) ABSTRACT

The present invention provides a deflection yoke having function of compensating for pin distortions in a middle portion in order to improve pincushion in the middle portion by arranging magnetic element of reverse direction on a diagonal of a screen portion of a coil separator in the deflection yoke. According to the present invention, an additional circuit is not required as it is in a related art, for suppressing pincushion phenomenon in the middle portion on the screen, so production cost could be reduced and power dissipation could be lowered, for the circuit for suppressing pincushion is not used.

### BACKGROUND OF THE INVENTION

1. Field of the Invention

The present invention relates to a deflection yoke for compensating for middle pin distortion generated in a CRT product (Cathode Ray Tube product) and more particularly to a deflection yoke having pin distortion compensating function for improving pincushion in a middle portion by arranging magnetic element of reverse direction to a diagonal direction of a screen portion of a coil separator in a deflection yoke.

2. Background of the Related Art

Recently, as a trend in a display market pursues continuously making a display flat, and strong point of a flat display, discriminating geographical distortion of a CRT product is highlighted seriously, upon comparison of a CRT product with a flat product such as LCD (Liquid Crystal Display) & PDP (Plasma Display Panel), a trend requiring quality improvement for geographical distortion of a CRT product, emerges.

With such trend, effort for compensating for misconvergence is speeded up. For compensation method for pin distortion among misconvergence, a method of varying inductance L value upon up and down deflection by using a pair of bias magnet for applying fixed bias to a pair of drum core having a wiring of a horizontal compensation coil and a variable bias coil having a wiring of a vertical compensation coil, has been generally used up to now.

The compensation method for pin distortion which has been disclosed in Japanese Patent Official Gazette Heisei 11-261839 will now be explained with reference to the accompanying drawings thereof.

FIG. 1 is a circuit diagram illustrating one example of a conventional compensation apparatus for compensation of pin distortion in a middle portion, and FIG. 2 is a side diagram illustrating major parts of a compensation reactor for compensation of pin distortion in the middle portion.

Referring to FIG. 1, the conventional compensation apparatus includes a compensation reactor 1 for compensation of pin distortion in the middle portion having two horizontal compensation coils L1, L2 connected in series, a vertical compensation coil L3, and a pair of magnets 2, 3 for applying magnetic field to the horizontal compensation coils 1, 2 and the vertical compensation coil L3. Here, the horizontal compensation coils L1, L2 are connected to a horizontal deflection circuit to modulate the vertical compensation coil L3 to have a vertical deflection current period, thereby generating magnetic field in the reverse direction to bias magnetic field. As a result, impedance of the horizontal compensation coils L1, L2 is varied to compensate for pin distortion in the middle units of the screen.

As illustrated in FIG. 2, the first compensation coil L1 wound on a first core 4, the second compensation coil L2 wound on a second core 5, and the vertical compensation coil L3 wound on a third core 6 are formed in the compensation reactor 1 for compensation of pin distortion in the middle portion.

In addition, one pair of magnets 2, 3 are positioned at both ends of the three cores 4˜6. One end of the magnets 2, 3 has polarity of S and the other end thereof has polarity of N.

Accordingly, the two horizontal compensation coils L1, L2 have wiring directions generating reverse direction magnetic fields. On the other hand, the vertical compensation coil L3 has a wiring direction generating magnetic field in the reverse direction to the magnetic field (bias field) generated by the pair of magnets 2, 3.

The conventional compensation apparatus for compensation of pin distortion on the screen compensates for lateral pin distortion of the screen by using the compensation reactor 1 for compensation of pin distortion in the middle portion.

Hereinafter, compensation process for pin distortion using a related art having the foregoing constitution will be described with reference to the accompanying FIG. 2 and FIG. 3.

When pin distortion phenomenon illustrated as shallow dotted lines on a second point P2 and a fourth point P4 in FIG. 3, is generated, magnetic field of the horizontal coils L1, L2 due to current flowing in a horizontal deflection circuit, is generated and inductance L values of an existing pair of horizontal coils L1, L2 drop down due to the magnetic field of the fixed bias of the permanent magnets 2, 3.

In addition, the variable bias generated in the vertical compensation coil L3 cancels, in opposite direction, the magnetic field of the permanent magnets 2, 3, whereby difference in inductance L values between up and down is generated, and resultantly pin distortions P2, P4 are compensated for, i.e., the portions illustrated by the shallow dotted lines disappear thanks to size difference in L values.

In order for compensation of pin distortion according to a related art as described above, wirings for the horizontal compensation coil and the vertical compensation coil are required, respectively, so productivity drop down and as dispersion occurrence depending on a wiring of a coil increases, problems that it is difficult to maintain stability in dispersion and characteristics of a pin in a middle portion and power dissipation soars up, have emerged.

Namely, as shown in FIG. 2, constituents of each core generate repulsive force by electromagnetic force of its own, respectively, thereby causing gaps, raising the foregoing problems.

### SUMMARY OF THE INVENTION

An object of the invention is to solve at least the above problems and/or disadvantages and to provide at least the advantages described hereinafter.

Accordingly, one object of the present invention is to solve the foregoing problems by providing a deflection yoke for compensating for distortion phenomenon in middle portions generated in the CRT product, particularly a deflection yoke having a function of compensating for pin distortion in the middle portions in order to improve pin cushion in the middle portion, by arranging magnetic elements of a reverse direction to a diagonal direction of a screen portion of a coil separator of the deflection yoke.

The foregoing and other objects and advantages are realized by a deflection yoke having a compensation function of pin distortion in a middle portion including: a coil separator having a screen portion coupled with a screen side of a cathode ray tube, a rear cover unit, and a neck unit extended from the center of the rear cover unit and coupled with an electron gun unit of the cathode ray tube; a deflection coil installed on the inner and outer circumference surfaces of the coil separator, for forming horizontal deflection magnetic field and vertical deflection magnetic field; a ferrite core installed on the outer surface of the coil separator for enhancing the magnetic field of the deflection coil; and more than one means for generating magnetic field provided for four divided quadrants of the screen portion of the coil separator so that deflection force can be changed depending on a screen portion to compensate for inner pin distortion.

Additional characteristic of the deflection yoke having the compensation function of pin distortion in the middle portion is that the means for generating magnetic field uses a magnetic element and more than two magnetic elements form one group, in which adjacent magnetic elements within one group are arranged opposite each other in their direction of the magnetic pole.

Another additional characteristic of the deflection yoke having the compensation function of pin distortion in the middle portion is that the means for generating magnetic field are respectively arranged in a positional angle range between (20°±5°)+90°×(n−1 and (60°±5°)+90°×(n−1) with n=1, 2, 3, 4, starting from +X axis of the divided quadrant on the screen portion.

Further another additional characteristic of the deflection yoke having the compensation function of pin distortion in the middle portion is that the directions of the magnetic poles of the magnetic elements maintain an arbitrary angle between 0° and ±90° starting from an Y-axis of the divided quadrant on the screen portion.

Still further another additional characteristic of the deflection yoke having the compensation function of pin distortion in the middle portion is that directions of the magnetic poles of the magnetic elements existing on a first quadrant and a third quadrant among the divided quadrants are matched each other by a rotational angle of 180°, and directions of the magnetic poles of the magnetic elements existing on a second quadrant and a fourth quadrant among the divided quadrants are also matched each other by a rotational angle of 180°.

According to another aspect of the invention, additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a circuit diagram illustrating one example of a conventional compensation apparatus for compensation of pin distortion in a middle portion;

FIG. 2 is a side diagram illustrating major parts of a compensation reactor for compensation of pin distortion in the middle portion in the conventional apparatus of FIG. 1;

FIG. 3 is an exemplary drawing illustrating a screen during the compensation of pin distortion in the middle portion;

FIG. 4 is an exemplary drawing for a compensation method for pin distortion in the middle portions according to the present invention;

FIG. 5 is an enlarged, exemplary drawing for part of FIG. 4, explaining a compensation method for pin distortion in the middle portions according to the present invention; and

FIG. 6 is an exemplary drawing explaining pin distortion compensation effect by a compensation method for pin distortion in the middle portions according to the present invention.

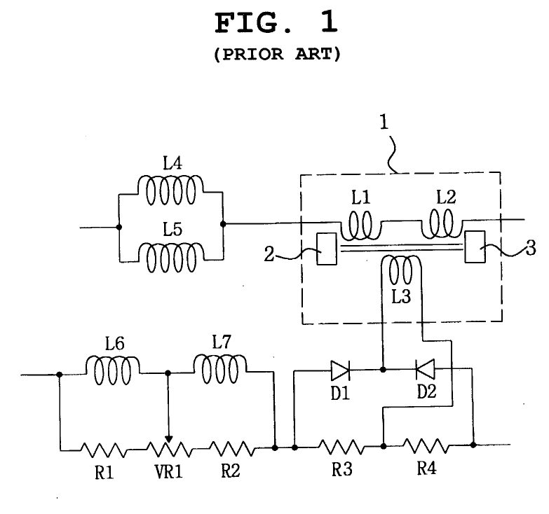

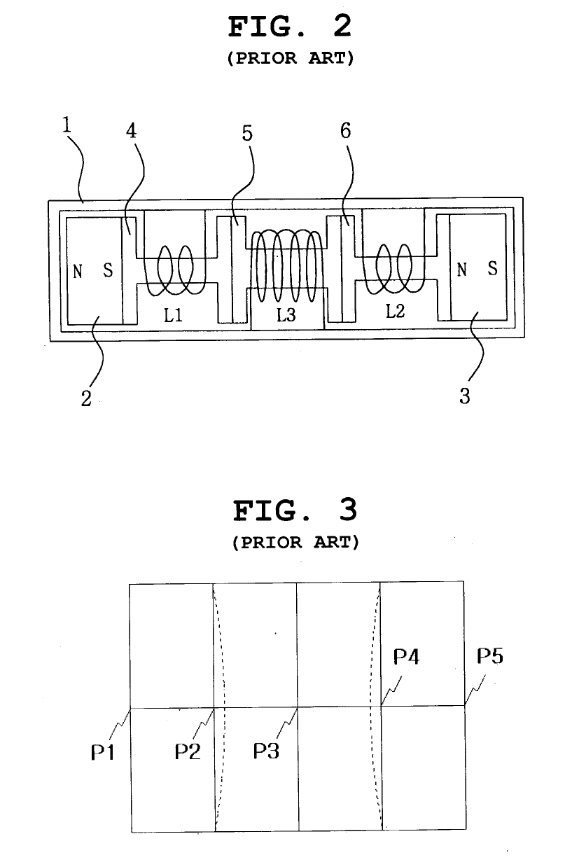

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### DETAILED DESCRIPTION OF PREFERRED EMBODIMENTS

The following detailed description will present a deflection yoke according to a preferred embodiment of the invention in reference to the accompanying drawings.

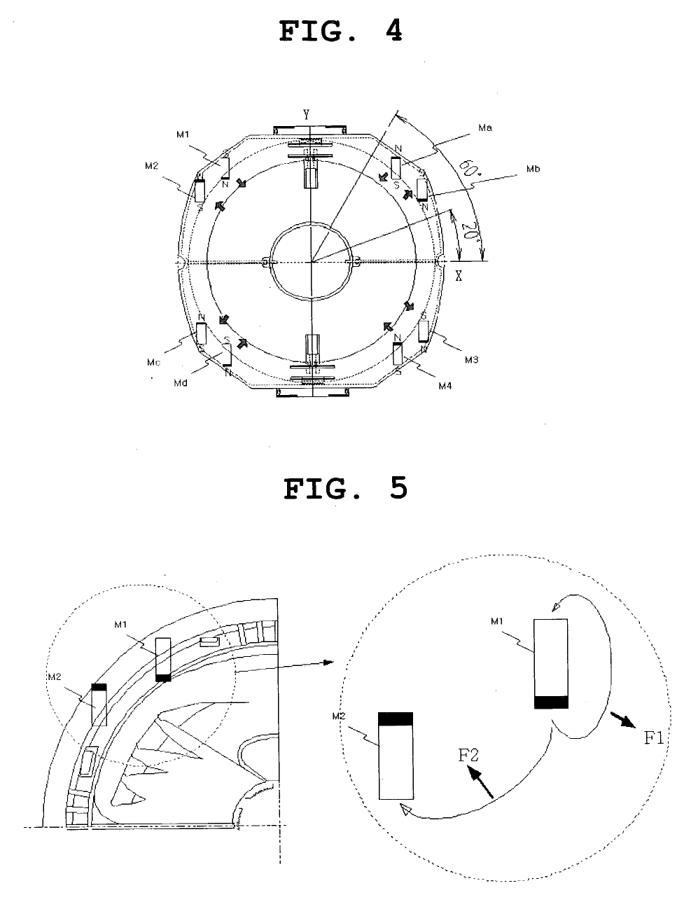

FIG. 4 is an exemplary drawing for a compensation method for pin distortion in the middle portions according to the present invention.

As shown in FIG. 4, magnetic elements of reverse direction are arranged in a diagonal direction in the edges of a screen portion as seen from a front side of a deflection yoke, namely on the front surface of the screen portion of a coil separator composing the deflection yoke.

At the moment, when it is assumed that a screen of the coil separator is divided into four quadrants, two magnetic elements form a pair, such pair of magnetic elements is arranged such that direction of magnetic pole of each magnetic element is opposite each other, and positional angles of the magnetic elements are in a range between 20°±5° and 60°±5° for respective quadrant.

Namely, position P on which the magnetic elements are positioned will be in the following range starting from +X axis, represented by the following mathematical formula:

[Formula]

{(20°±5°)+90°×(n−1)}≦P≦{(60°±5°)+90°×(n−1)}

With n=1, 2, 3, 4

Also, the magnetic elements are arranged in parallel with a Y-axis passing through a center portion of the screen portion of the coil separator, and a pair of magnetic elements Ma, Mb existing on a first quadrant and a pair of magnetic elements Mc, Md existing on a third quadrant of the screen in the deflection yoke, are the same in their direction of magnetic pole.

In the meantime, a pair of magnetic elements M1, M2 existing on a second quadrant and a pair of magnetic elements M3, M4 existing on a fourth quadrant of the screen portion in the deflection yoke, are also the same in their direction of magnetic pole, but opposite to the direction of a pair of the magnetic elements existing on the first quadrant and the third quadrant.

Here, more specific explanation of description that pairs of magnetic elements existing on the first and the third quadrants of the screen portion of the core separator, are the same in their direction of magnetic pole, respectively, and description that pairs of magnetic elements existing on the second and the fourth quadrants, are the same in their direction of magnetic pole, respectively, reveals the following description.

Namely, pairs of magnetic elements existing on each quadrant of the screen portion are mounted oppositely in an oblique direction with the same magnetic pole, respectively, i.e., the directions of the magnetic pole of the pair of magnetic element existing on the first and the third quadrants are matched by a rotational angel of 180° and the directions of the magnetic pole of the pair of magnetic element existing on the second and the fourth quadrants are also matched by a rotational angel of 180°.

Also, pairs of magnetic elements existing on the first and fourth quadrants are mounted with the same magnetic pole such that their directions of the magnetic pole may be parallel with a Y-axis passing through the center of the screen portion, and the same is true of pairs of magnetic elements existing on the second and third quadrants.

Therefore, as described above, force is exerted due to magnetic field direction generated by each pair of magnetic elements due to the direction of the magnetic pole of each magnetic element pair existing on the first quadrant through the fourth quadrant, and the force exerted in this manner is generated in directions as represented by arrows in FIG. 4.

Detailed manner in which the force is exerted due to magnetic field direction generated by each pair of the magnetic elements will be described with reference to FIG. 5. FIG. 5 is an enlarged, exemplary drawing for part of FIG. 4, explaining a compensation method for pin distortion in the middle portions according to the present invention and, more specifically, FIG. 5 is a drawing for part of the second quadrant in FIG. 4, prepared for examination of force direction generated by the pair of magnetic elements existing on the relevant second quadrant.

In FIG. 5, force due to magnetic field generated by a pair of the magnetic elements M1, M2 is generated in a direction as indicated by a reference numeral F1 under influence of the magnetic element M1, and force is also generated in a direction as indicated by a reference numeral F2 under influence of the magnetic elements M1, M2, whereby the deflection force of the electron beam irradiated from the electron gun is changed depending on positions on the screen.

In the foregoing, though the direction of the magnetic pole of the magnetic element has been described in detail based on the accompanying FIG. 4 and FIG. 5, actually direction of the magnetic pole of each the magnetic element lies in an angle of range between 0° and ±90° starting from a Y-axis, thereby exerting force differently, influencing differently on the deflection of the electron beam depending on positions on the screen.

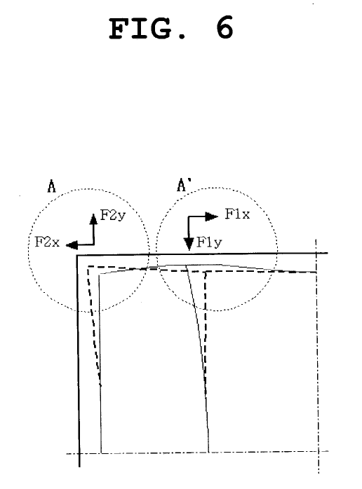

Examination of an example for pincushion suppression effect according to the foregoing description, reveals, as shown in FIG. 6, that a portion indicated by a reference numeral A and a portion indicated by a reference numeral A′ on the screen, are given force of different direction, respectively, whereby pincushion phenomenon in the middle portion on the screen could be suppressed properly.

FIG. 6 is an exemplary drawing explaining pin distortion compensation effect by a compensation method for pin distortion in the middle portions according to the present invention, representing a screen portion corresponding to FIG. 5. Pincushion phenomenon before improvement is seriously distorted in the middle portions as represented by solid lines, while pincushion phenomenon after improvement is suppressed in the middle portions as represented by dotted lines thanks to forces F1, F2 generated by arrangement of a pair of the magnetic elements in FIG. 5.

Namely, portion indicated by a reference numeral A′ is given force indicated by F1 in FIG. 5. At the moment, the force F1 is decomposed into F1x and F1y by vector analysis and deflection swollen to +Y axis direction is pushed down by the force F1y, and deflection to −X axis direction is suppressed by the force F1x.

In the meantime, portion indicated by a reference numeral A is given force indicated by F2 in FIG. 5. At the moment, the force F2 is decomposed into F2x and F2y by vector analysis, whereby normal edges of the screen are deflected to −X axis and +Y axis directions, respectively, due to forces F2x and F2y.

Edge portions of the screen, however, are not perceived much by human eyesight actually. Therefore, image quality is improved on the whole by suppression of problematic distortion phenomenon in the middle portion of the screen.

As is apparent from the foregoing, the deflection yoke having compensation function for pin distortions in the middle portion according to the present invention, does not require an additional circuit for suppressing pincushion phenomenon in the middle portion of the screen as is necessary for a related art, reducing production costs. Further, power dissipation could be reduced, for the circuit for suppressing pincushion is not used.

Also, in a related art, it was difficult to maintain stability in dispersion and characteristics of a pin in the middle portion as dispersion generation increases due to a wiring of a coil, but such difficulty could be resolved according to the present invention.

While the invention has been shown and described with reference to certain preferred embodiments thereof, it will be understood by those skilled in the art that various changes in form and details may be made therein without departing from the spirit and scope of the invention as defined by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art.

What is claimed is:

1. A deflection yoke having a compensation function of pin distortion in a middle portion, comprising:
a coil separator having a screen portion coupled with a screen side of a cathode ray tube, a rear cover unit, and a neck unit extended from the center of the rear cover unit and coupled with an electron gun unit of the cathode ray tube;
a deflection coil installed on the inner and outer circumference surfaces of the coil separator, for forming horizontal deflection magnetic field and vertical deflection magnetic field;
a ferrite core installed on the outer surface of the coil separator for enhancing the magnetic field of the deflection coil; and
more than one means for generating magnetic field provided for four divided quadrants of the screen portion of the coil separator so that deflection force can be changed depending on a screen portion to compensate for inner pin distortion

2. The deflection yoke according to claim 1, wherein the means for generating magnetic field uses a magnetic element and more than two magnetic elements form one group, in which adjacent magnetic elements within one group are arranged opposite each other in their direction of the magnetic pole.

3. The deflection yoke according to claim 1, wherein the means for generating magnetic field are respectively arranged in a positional angle range between (20°±5°)+90°×(n−1) and (60°±5°)+90°×(n−1) with n=1, 2, 3, 4, starting from +X axis of the divided quadrant on the screen portion.

4. The deflection yoke according to claim 2, wherein the directions of the magnetic poles of the magnetic elements maintain an arbitrary angle between 0° and ±90° starting from an Y-axis of the divided quadrant on the screen portion.

5. The deflection yoke according to claim 4, wherein the directions of the magnetic poles of the magnetic elements existing on a first quadrant and a third quadrant among the divided quadrants are matched each other by a rotational angle of 180°, and directions of the magnetic poles of the magnetic elements existing on a second quadrant and a fourth quadrant among the divided quadrants are also matched each other by a rotational angle of 180°.
